(19) United States
(12) Patent Application Publication
(10) Pub. No.: US 2016/0353706 A1
(43) Pub. Date: Dec. 8, 2016

(54) CAT LITTER SIEVING SYSTEM

(71) Applicants: John Gallagher, Hamilton (CA); Mary Gallagher, Hamilton (CA)

(72) Inventors: John Gallagher, Hamilton (CA); Mary Gallagher, Hamilton (CA)

(21) Appl. No.: 14/728,348

(22) Filed: Jun. 2, 2015

(51) Int. Cl. A01K 1/01; B65D 75/14; B65D 33/16; B65D 65/06; B07B 1/04; B07B 11/06

(52) U.S. Cl. CPC A01K 1/0114; B07B 1/04; B07B 11/06; B65D 33/1608; B65D 65/06; B65D 75/14

(57) ABSTRACT

A cat litter sieving system comprises a litter handler convertible between a flat configuration, an open container configuration, a transport configuration, and a disposal configuration, and sieve. The sieve comprises a riser to retain a frame at a selected distance above a litter box, said frame supporting a mesh member having a perimeter and defining a plurality of holes therethrough of sufficient size to permit granules of cat litter to pass through while retaining clumps of cat litter.

### FIELD OF THE INVENTION

The disclosure herein relates to systems for sieving solidified waste from granular cat litter material to dispose of the waste and reuse the cat litter.

### BACKGROUND OF THE INVENTION

The owners of indoor domestic cats typically provide one or more cat litter boxes in the home. A cat litter box serves as a place for cats to relieve themselves. The litter box is filled with cat litter. Cat litter is usually composed of many individual particles or granules of clay, crushed nut hulls, paper pulp etc. Commonly cat litter is of the “clumping” type, meaning that the individual granules clump together in the presence of urine or feces, absorbing the fluids and odor. The clumps of litter must be removed and fresh litter added on a regular basis. Alternatively, the entire contents of the litter box including cat waste and the remaining unused litter must be dumped and replaced. Dumping the entire contents of the box results in very rapid use of an owner's supply of cat litter since a large quantity cat litter which has not come into contact with urine or feces will be dumped out along with the soiled litter.

The simplest way to remove the clumps of waste is to dig each of the clumps out with a slotted spoon or scoop, transfer them into a trash bag, and discard them. Often smaller soiled clumps will pass through or fall off the scoop and remain in the litter box. This means that the litter box is never completely clean of cat waste after the scooping has been done. Occasionally the clumps break up while being transferred into the trash bag, creating a greater mess. Scooping out clumps of waste from the litter box is an unpleasant daily task for cat owners. Cat owners always need to keep a supply of small trash bags on hand to receive the soiled clumps. Some owners also purchase protective gloves to cover their hands so that they do not have to touch soiled litter while cleaning the litter box.

The job of cleaning out the litter box is made further unpleasant if the box only contains a thin layer of cat litter. When cats urinate onto a thin layer of cat litter, the urine pools in the bottom of the box before it can be absorbed into the cat litter. This results in the wet mixtures of litter and urine sticking to the bottom of the box. When the owner attempts to scoop out the soiled litter out of the box, it is not possible to get the scoop under the soiled litter. The owner then needs to find an alternate tool to scrape the stuck on soiled litter off the bottom of the box. Subsequent washing of the litter box is often also required. One possible solution is to place a deep layer of litter (3 inches or more) into the box. This increases the amount of litter purchased and used. It has also been observed that when large quantities of cat litter are present, cats will spend more time digging in the litter and toss quantities of it out of the box, leaving a mess on the floor. It would be advantageous to have a system for cleaning a litter box which requires only a shallow layer of cat litter, and which prevents the problem of soiled litter sticking to the bottom of the litter box.

There are many cat litter sieving systems known. However, each system has drawbacks. For example, one system provides a stack of plastic sheeting box liners each having sifting holes in it, and one liner without holes at the bottom of the stack. The entire stack is placed into a litter box and then filled with litter. After a cat has used the litter, the top liner lifted up above the box, allowing loose litter to fall through the holes and back into the box, while the clumps of soiled litter are retained in the top liner. The top liner is then transferred to a garage bag or can for disposal. This system has a number of disadvantages. Granular cat litter and small clumps may escape the top liner while it is being transferred to a garbage bag or can, creating a mess in the area. Also, the stack of liners may become torn when the cat digs in the litter, and become less effective at its sieving function. Furthermore, it is possible for the stack of perforated liners to move out of position when the cat digs in the litter. This may result in waste material being deposited between the liners, or under the liners in the cat box, creating a mess.

Another system provides a stack of nested litter boxes, the top one perforated with sieving holes, and the bottom two being solid. Litter is placed into the nested boxes. After use by the cat, the perforated top liner is lifted and shaken gently sifting the granular litter into the bottom litter box and retaining clumps of soiled litter in the top box. This system requires multiple component parts which must be used together. Additionally, the soiled clumps of litter must still be transferred in the top perforated box and poured out into a waste receptacle, with the potential for spills to occur.

Still other systems provide a litter box which has a built in sieve component. Typically there are multiple chambers: one containing litter used by the cat, a repository for clumps of soiled litter, and a sieving element imposed between the chambers. The box and/or some of its structural components are moved in order to bring the litter into contact with the sieving element. Systems of this type often have complex movable parts which increase the cost of the system and may predispose the system to malfunction or breakage. These systems require the use of dedicated litter boxes of special shapes. They cannot be used with existing litter boxes and parts are not interchangeable with existing boxes.

It would be desirable to have a system for cleaning a cat litter box that eliminates the need for manually scooping up and removing clumps of waste. Preferably the user could use the system without their hands contacting soiled cat litter.

Preferably the system would not require a sieve containing soiled litter to be transported over distances in order to dispose of soiled litter in a trash can or bag.

The system should be cost effective to manufacture and easy and convenient to use.

### SUMMARY OF THE INVENTION

A cat litter sieving system comprises a litter handler convertible between a flat configuration, an open container configuration, a transport configuration, and a disposal configuration, and sieve.

The litter handler comprises a sheet having a first side and a second side; a first tab extending from said first side, a second tab extending from said second side; a first end and a third tab extending from said first end. The litter handler further comprises a shaping element to form the sheet into the open container configuration.

The shaping element is a curvature heat formed in the sheet to divide the sheet into a substantially planar polygonal base, and a plurality of interconnected wall panels extending upwardly from the substantially planar polygonal base to form the open container configuration.

In an alternative embodiment, the shaping element is a plurality of fold lines in the sheet defining substantially planar polygonal base and a plurality of interconnected wall panels; and wherein said plurality of interconnected wall panels may be folded upward from said plurality of fold lines to form an open container.

The plurality of fold lines comprise a center fold line extending inwardly from a corner of the sheet and substantially bisecting said corner; a first lateral fold line and a second lateral fold line; said first lateral fold line and said second lateral fold line positioned one on either side of the center fold line and extending inwardly to converge with the center fold line.

The sieve comprises a riser to retain a frame at a selected distance above a litter box, said frame supporting a mesh member having a perimeter and defining a plurality of holes therethrough of sufficient size to permit granules of cat litter to pass through while retaining clumps of cat litter.

A method of removing clumps of cat litter contaminated with waste material from a granular cat litter comprises the following steps. A litter handler comprising a sheet having a first side and a second side; a first tab extending from said first side, a second tab extending from said second side; a first end and a third tab extending from said first end is placed into a car litter box with the first tab, the second tab and the third tab extending outside the litter box. Granular cat litter is placed inside the litter handler. After some of the granular cat litter has been soiled causing clumps of cat litter contaminated with waste material, a user brings the first tab into contact with the second tab forming the transport configuration of the litter handler containing the cat litter and cat litter clumps. The litter handler is lifted out of the litter box. The next is placing into the litter box a sieve comprising a riser to retain a frame at a selected distance above a litter box, said frame supporting a mesh member having a perimeter and defining a plurality of holes therethrough of sufficient size to permit granules of cat litter to pass through while retaining clumps of cat litter. The cat litter is poured from the litter handler into the sieve. After all of the granular cat litter has passed through the sieve leaving clumps of cat litter in the sieve, the sieve is removed from the litter box. The clumps of cat litter are returned to the litter handler for disposal.

### BRIEF DESCRIPTION OF THE DRAWINGS

FIG. 1A is a plan view of a litter handler according to the present invention shown in a flat configuration.

FIG. 1B is a perspective view of the litter handler of FIG. 1A shown in an open container configuration.

FIG. 2 is a perspective view of an alternative embodiment of the litter handler deployed in a cat litter box.

FIG. 3 is a perspective view of the litter handler of FIG. 2 containing granular cat litter.

FIG. 4 is a perspective view of the litter handler of FIG. 2 containing granular cat litter and clumps of litter contaminated with waste matter.

FIG. 5 is a perspective view of the litter handler of FIG. 2 being converted into the transport configuration and lifted out of the litter box.

FIG. 6 is a perspective view of a sieve being placed into the litter box.

FIG. 7 is a perspective view of the sieve in the litter box.

FIG. 8 is a perspective view of the litter handler transporting the granular cat litter and clumps of litter contaminated with waste matter into the sieve.

FIG. 9 is a perspective view of the clumps of litter contaminated with waste matter retained in the sieve and the granular cat litter inside the litter box.

FIG. 9A is a perspective view of litter box containing granular cat litter after the sieve containing the clumps of litter contaminated with waste has been removed.

FIG. 10 is a perspective view of the contents of the sieve being emptied into the litter handler.

FIG. 11 is a perspective view of the litter handler in a disposal configuration.

FIG. 12A is a perspective view of a sieve according to an alternative embodiment of the present invention.

FIG. 12B is an exploded view of the sieve of FIG. 12A.

FIG. 13A is an exploded perspective view of a sieve according to an alternative embodiment of the present invention.

FIG. 13B is a perspective view of the sieve of FIG. 13A shown in a collapsed configuration.

FIG. 14 is a plan view of an alternative embodiment of the litter handler according to the present invention shown in a flat configuration.

### DETAILED DESCRIPTION OF EMBODIMENTS

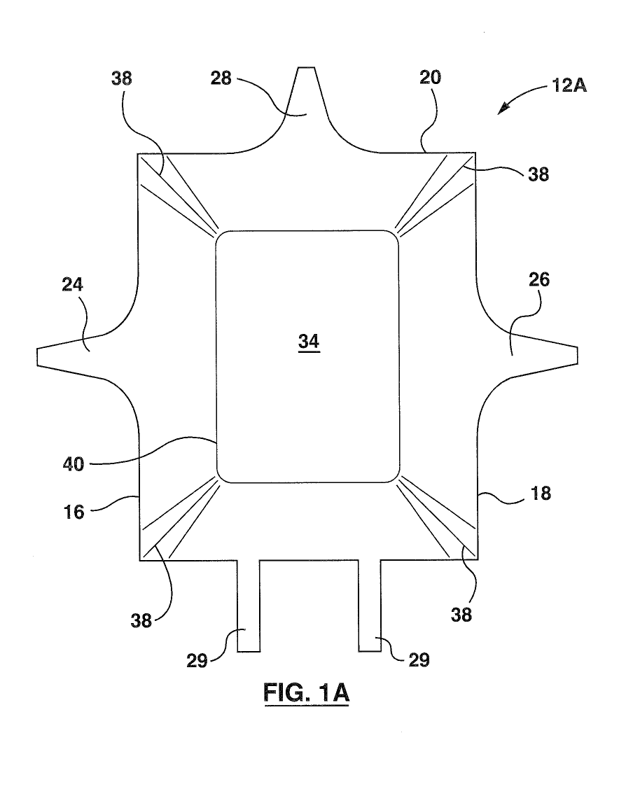

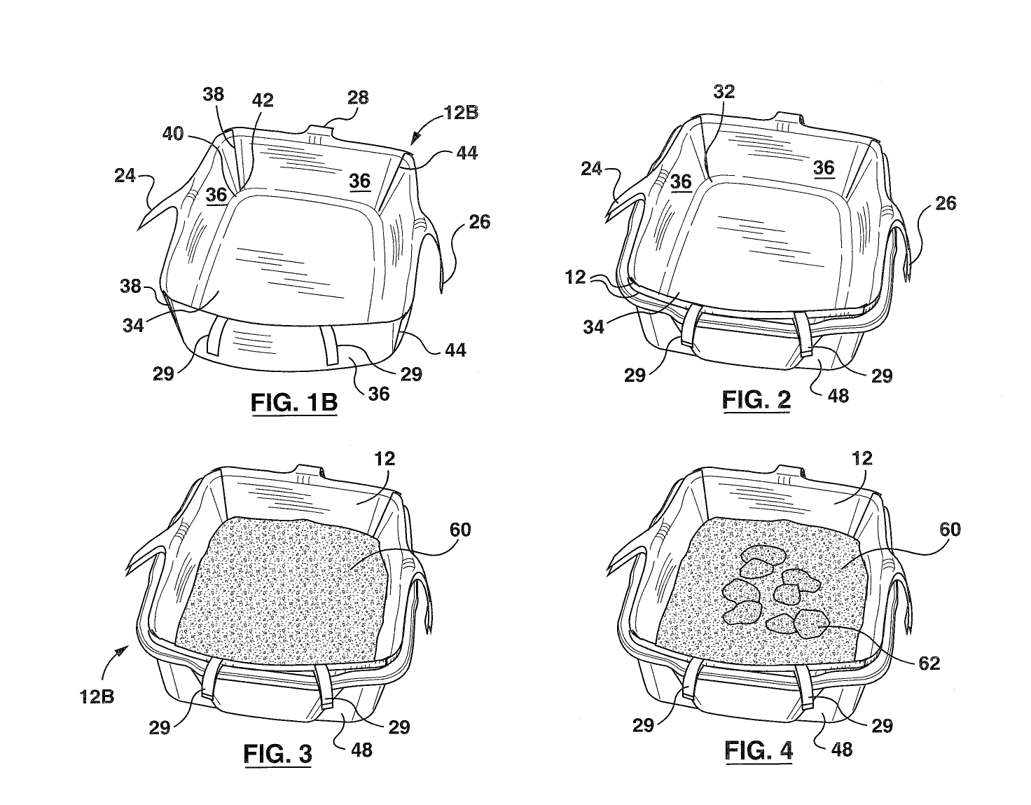

The present invention provides a cat litter sieving system shown in the accompanying figures generally by reference numeral 10. The cat litter sieving system comprises a litter handler 12 and a sieve 13. As shown in FIG. 1A, the litter handler 12 comprises a sheet 14. The sheet 14 has a first side 16 and a second side 18; and a first end 20. A first tab 24 extends from the first side 16. A second tab 26 extends from the second side 18, and a third tab 28 extends from the first end 20 of the sheet 14. Optionally, the sheet 14 has a second end 22. A pair of dust retainers 29, 29 extends from the second end 22 of the sheet 14.

The sheet 14 can be fabricated from a flexible sheeting material. The sheet is preferably, though not necessarily water resistant. The sheet may be constructed from a variety of flexible sheeting materials, including waterproof paper, wax paper, polyethylene terephthalate (PET), cellulose acetate, polyvinyl chloride (PVC), polythene, nylon, acrylic, textile, and fabric. The sheet 14 is preferably constructed from high density polyethylene, having a sheet thickness in the range of 50.8 μm to 101.60 μm. The material is high density polyethylene having of 76.2 μm. A person skilled in the art will recognize that other suitable materials may be used without departing from the present invention.

The sheet may also be treated to provide fragrances and/or odor eliminating additives. In a further modification, the sheet may be constructed from moisture sensitive materials so that when the contained litter becomes moist from use, the sheeting material changes colour to provide a visual indication. This will alert the owner that the litter has become soiled and requires removal.

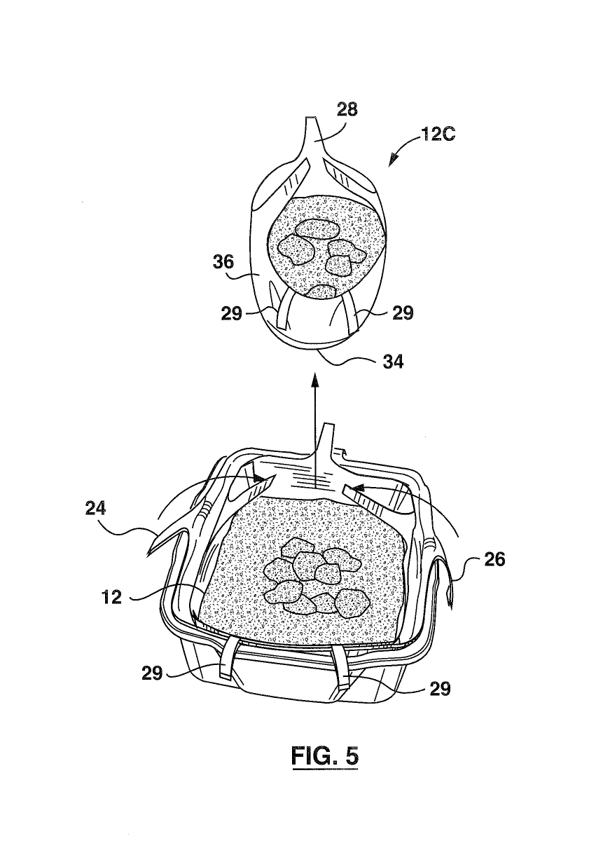

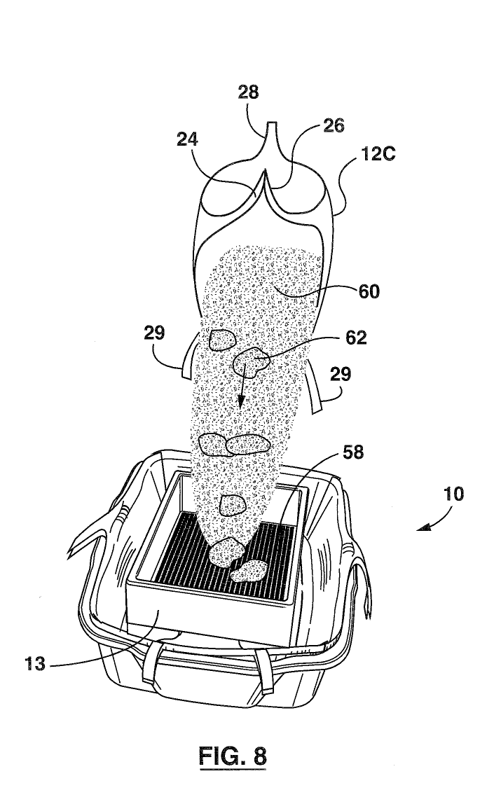

The litter handler 12 is convertible between a flattened configuration 12A shown in FIG. 1A, an open container configuration 12B as shown in FIG. 1B, a transport configuration 12C as shown in FIG. 5 and FIG. 8, and a disposal configuration 12D as shown in FIG. 11.

A shaping element 30 serves to form the sheet 14 into the open container configuration. Several embodiments of the shaping element are possible.

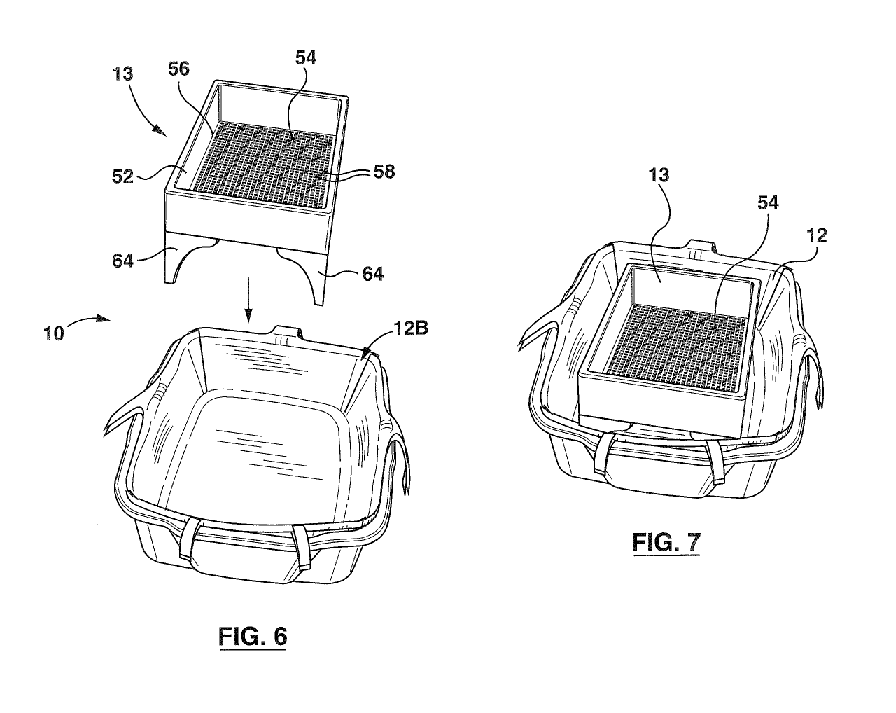

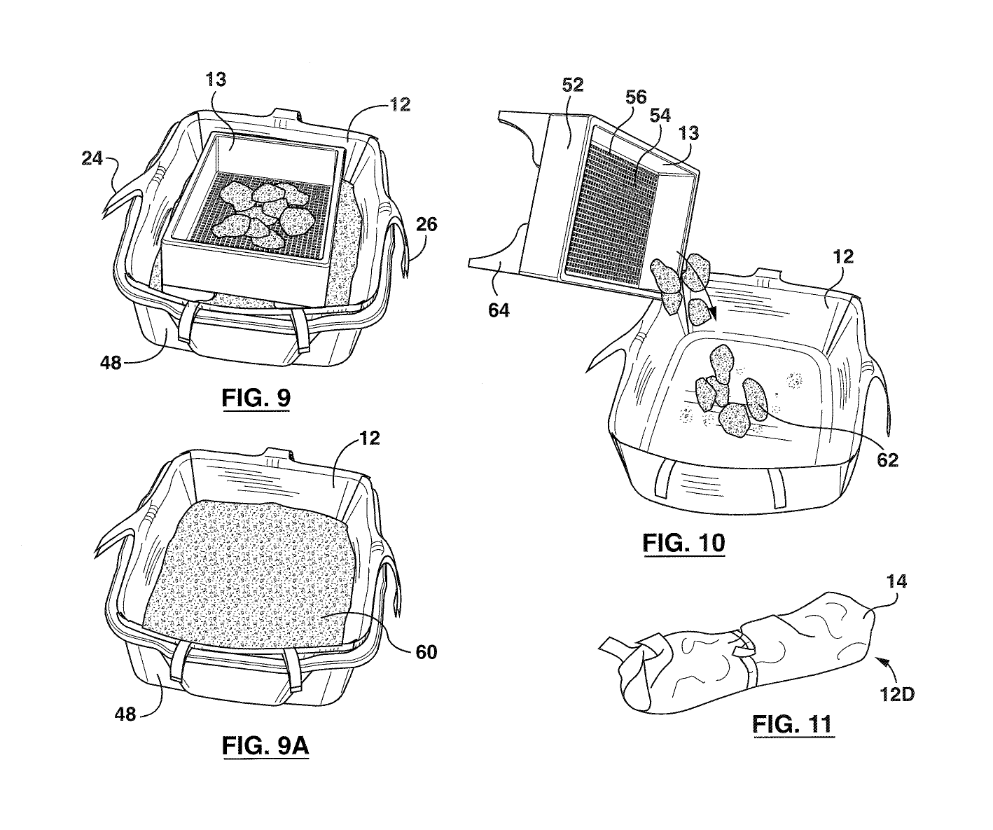

In a first embodiment, shown in FIG. 2 through FIG. 11, the shaping element 30 is a curvature 32 formed in the sheet 14 to divide the sheet into a substantially a planar polygonal base 34, and a plurality of interconnected wall panels 36 extending upwardly from the substantially planar polygonal 34 to form the open container configuration. It is preferred that the base 34 will be generally rectangular, though having curved corners. The generally rectangular shape matches the generally rectangular shape of conventional cat litter boxes. It should be understood that the particular shape of the base 34 is not determinative of the present invention, but rather sheets may be manufactured in variety of base shapes for use with a variety of litter box shapes. In the first embodiment, the curvature 32 is created through plastic forming techniques. It will be understood by a person skilled in the art that a formed curvature is an appropriate shaping element 30 in instances where the sheet 14 is constructed from a material which can be formed.

In an alternative embodiment shown in FIG. 1A and FIG. 1B, the shaping element 30 is a plurality of fold lines in the sheet defining substantially planar polygonal base and a plurality of interconnected wall panels. The fold lines are located at each of the corners of the sheet. A centre fold line 38 substantially bisects each corner of the sheet 14. At each corner, a first lateral fold line 40 and a second lateral fold line 42 are spaced equidistant from the first fold line 38. The first 40 and second 42 lateral fold lines extend inwardly from the edges of perimeter of the sheet and substantially converge to meet the centre fold line 38. When the corners of the sheet are folded about each centre fold line 38 such that the respective first lateral fold line 40 and second lateral fold line 42 are closely adjacent with each other, the handler 20 is shaped into its open container configuration. The handler 12 can then be placed into a litter box for use.

The sheet 14 can be heat crimped along the meeting of each respective first lateral fold line 40 and second lateral fold line 42 in order to form a heat sealed gusset corner 44. FIG. 1B shows a handler having heat sealed gusset corners. The formation of gusset corners 44 improves the strength and stability of the handler 12, allowing it to retain its open container configuration even when it is not supported by the walls of a cat litter box. The handler 12 can still be folded into a flat storage configuration 12A since it is constructed from a flexible material.

In an alternative embodiment, the shaping element is a plurality of score lines. The positioning and direction of the score lines would be the same as discussed in above with regard to fold lines. The choice between score lines and fold lines is a function of the material selected for manufacture of the sheet 14. If the material is such that it can be readily folded, such as paper then fold lines will be used. If the material selected does not readily remain folded, a pattern of score lines may be scored into the sheet during the manufacturing process as a shaping element to form the sheet into the open container configuration. Since the positioning remains the same whether fold lines or score lines are used, FIG. 1A illustrates the positioning of either fold lines or score lines, and the reference numerals 38, 40, 42, 44 are equally applicable to reference the respective score lines or fold lines.

The litter handler is deployed in a litter box 48 with the first tab 24, the second tab 26, the third tab 28, and the pair of dust retainers 29, 29 each extending over a respective side and/or end of the litter box. The base 34 of the litter handler 12 rests on the bottom of the litter box 48, and the sides 36 are held in position along the sides of the litter box by the tabs 26, 28, and the dust retainers 29, 29 extending over the sides of the litter box. Clean granular cat litter 60 can then be placed into the litter box 48 for use by a cat.

When it is time to remove clumps 62 of soiled litter from the litter box, the litter handler is converted into the transport configuration. The first tab 24 is located on the first side of the sheet 16 and is centred with respect to first side 16. The second tab 26 is located on the second side 18 in a centred position. Thus, the first tab 24 and the second tab 26 are positioned opposite one another. The user brings the first tab 24 into contact with the second tab 26 and holds them securely together forming the transport configuration 12C. The positioning of first tab 24 and second tab 26 opposite one another and each at the centre of its respective side 16, 18 of the sheet 14 serve to balance the cat litter 60,62 within the litter handler 12. Tabs 24 and 26 serve as lifting handles to lift the litter handler 12 and its contents. It should be noted that the sheet 14 which forms the litter handler 12 is not perforated, and has no sieving holes. The base 34 supports both the granular cat litter 60 and the clumps 62 of litter contaminated with waste material. The interconnected wall panels 36 are contiguous with the base 34 and serve to prevent litter 60, 62 from spilling out of the litter handler 12. The litter handler 12 is then used to lift the cat litter 60, 62 from the litter box 48 in order to be sieved. The third tab 28 can be grasped by the user in order to further stabilize the litter handler 12. The tab 28 further serves as a handle to guide and direct the flow of cat litter 60, 62 as it is being poured into the sieve 13. The dust retainers 29, 29 positioned on the second end 22 of the sheet 14 are each allowed to hang down. When the litter is being poured from the handler 12, the pair of tabs is located one on either side of the stream of cat litter 60, 62 while it pours from the litter handler 12. The dust retainers 29, 29 act to direct dust and fine particles toward the centre of the flow of cat litter 60, 62. This action lessens the amount of litter dust which would otherwise rise whenever cat litter is poured from one vessel into another.

In a simplified embodiment of the litter handler 12, the sheet 14 remains flat and planar until it is deployed in a litter box 48 with the first tab 24, the second tab 26, the third tab 28, and the pair of dust retainers 29, 29 each extending over a respective side and/or end of the litter box. Once deployed, the sheet takes on an open container shape as it lies in the box suspended by the tabs 24, 26, 28, and dust retainers 29, 29. In this embodiment, the sheet is shaped into the open container configuration by the interplay of the suspension of the sheet 14 by the tabs 24, 26 and 28 and the sides 16, 18 and ends 20, 22 resting against the sides and ends of the litter box 48. This simplified embodiment is less preferred than the other embodiments, since the sheet 14 may become dislodged from its resting place if the tabs may slip out of their extended positions over the sides of the litter box 48. Additionally, when the litter handler 12 is removed from the litter box and laid down on a flat surface, it will revert to its flat configuration. This means that the litter handler 12 according to the simplified embodiment cannot be laid down on a flat surface while it is full of cat litter. It will be laid flat when it is to be used for disposal of litter clumps contaminated with waste material. The litter clumps will be poured onto the litter handler 12 from the sieve (discussed below), and there is the potential for litter clumps to roll off of the litter handler before it is folded or rolled around the litter clumps to form the disposal configuration.

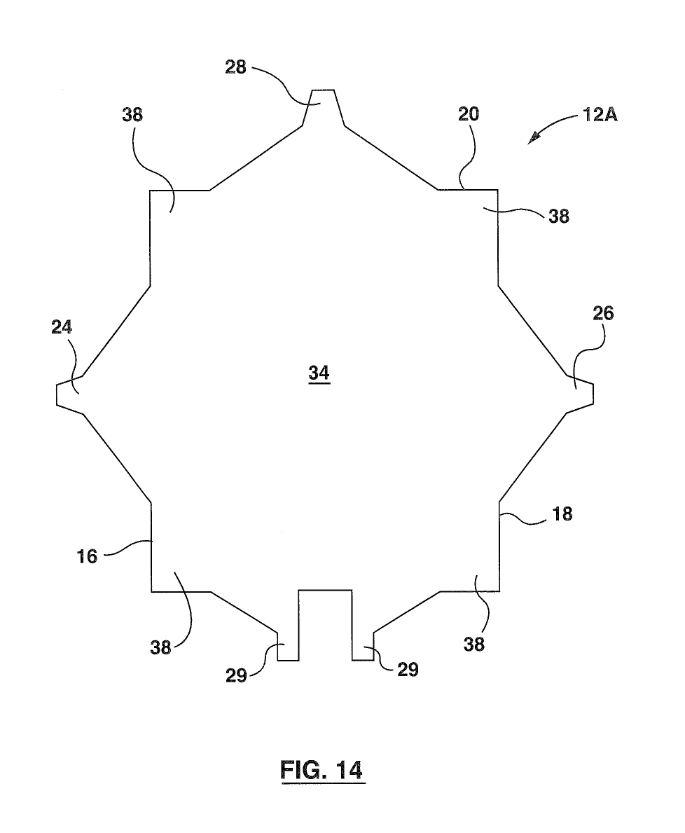

FIG. 14 shows an alternative embodiment of the litter handler 12. It should be noted that in accordance with this embodiment, the tabs 24, 26, and 28 of sheet 14 have been expanded in size. Each of the tabs 24, 26 and 28 still protrude respectively from sides 16, 18, and 20; but the width of the tabs has been significantly increased immediately adjacent to each of the sides 16, 18 and 20. The width of each of the tabs at their widest points are approximately equal to ½ the length of the respective side. In this embodiment the tabs have a larger surface area which means there is more sheet material in the tabs providing greater strength. The litter handler 12 of this embodiment is stronger and more stable for lifting soiled litter from a litter box. Additionally, the tabs 24, 26 and 28 each have a wide base area before tapering to a narrower squared end. The large tapered area is less likely to fall back into the litter box if a cat digs or paws at the litter handler. In this embodiment, the dust retainers 29, 29 have also been widened.

Typically the clumps 62 of cat litter contaminated by waste material are significantly larger than granular cat litter 60, and can be readily separated by sieving. The sieving system 10 of the present invention further comprises a sieve 13. The sieve 13 comprises a riser 50 to retain a frame 52 at a selected distance above a litter box 48. The riser could be an extension of the frame. Alternatively, the riser 50 could be comprised of multiple legs 68. The frame 52 supports a mesh member 54.

The mesh member 54 has a perimeter 56 and defines a plurality of holes 58 therethrough. The mesh member 54 may be woven, extruded, expanded, knitted, or electroformed. It may likewise be constructed from a variety of suitable materials including plastics, metals, and other durable materials. The mesh member 54 is preferably molded from a plastic material. The holes 58 of the mesh member must be of a sufficient size to permit cat litter granules 60 to pass through easily, while retaining clumps 62 of cat litter contaminated with waste material. The selection of a material from which to construct the mesh member 54, and the particular size and shape of the holes 56 is within the ability of a person ordinarily skilled in the art. By way of example only, it has been determined that a mesh having holes 58 approximately 8 mm by 8 mm in size and separated from one another at a distance of approximately 2 mm is suitable to retain clumps while allowing granules of litter to pass through. The particular shape of the holes is not determinative, so long as the passage of litter granules is not impeded.

The frame 52 of the sieve 13 extends above the mesh member 54 at all points along the perimeter 56 thereof to form a box structure with the mesh member 54 being the bottom of the box structure. This box structure retains the granules 60 of cat litter and any clumps 62 in contact with the mesh member 54 so that the cat litter granules 60 may be separated from the clumps 62.

There are multiple embodiments of the sieve 13 according to the present invention. In the simplest embodiment, the sieve 13 can be constructed as a single body molded from plastic. The riser 50 may simply be a downward extension of the frame 52 to retain the frame 52 at a selected distance above a litter box 48 when in use. A suitable distance would be approximately 8 cm but could be varied without departing from the present invention. Alternatively, the riser 50 may comprise a plurality of legs.

The sieve 13 is reusable and can be stored between uses. The same sieve 13 can be with any new or existing litter box. In alternative embodiments, the sieve can be constructed in parts and can be disassembled for more compact storage.

In one embodiment, the riser 50 comprises a plurality of legs that are removably supportingly attached to the frame 52. Fastening elements (not shown) can be provided on the legs and frame for a friction fit, or other conventional fastening.

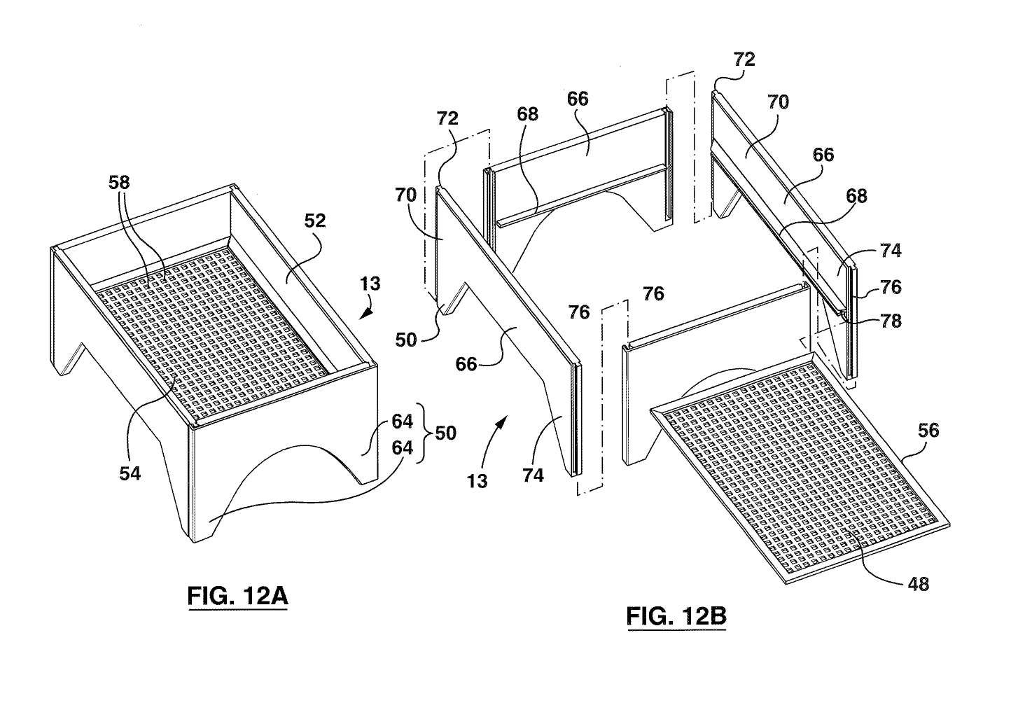

Alternatively, as shown in FIGS. 12 A and 12B, the frame 52 comprises a plurality of side panels 66. Each of the side panels 66 defines a riser 50 and a support 68 for the mesh member 56. Each of said side panels 66 having a first end 70 having a means 72 for retainingly mating another one of said plurality of side panels 66. Each of said side panels 66 also has a second end 74 having a second means 76 for retainingly mating with another one of said plurality of side panels. As illustrated in FIGS. 12A and B, the first mating means 72 and the second mating means 74 may be tongue and groove components. Other conventional mating means may be used. It does not matter whether two of the panels 66 have the same first mating means 72 and second mating means 74 (i.e. both tongues) or two different complementary mating means (one tongue and one groove) so long as the panels may be retaining mated to form the frame 52. Each of the panels has a support 68 for the mesh member 56. The support 68 may be a ledge extending from the panel 66, such that when all of the panels 66 are connected, the ledges are aligned and the mesh member can rest securely on the ledges, suspended above a litter box 48 at a distance determined by the height of the riser 50. Alternatively, the support 68 may be contoured as a channel 78 to slidingly receive and support the mesh member.

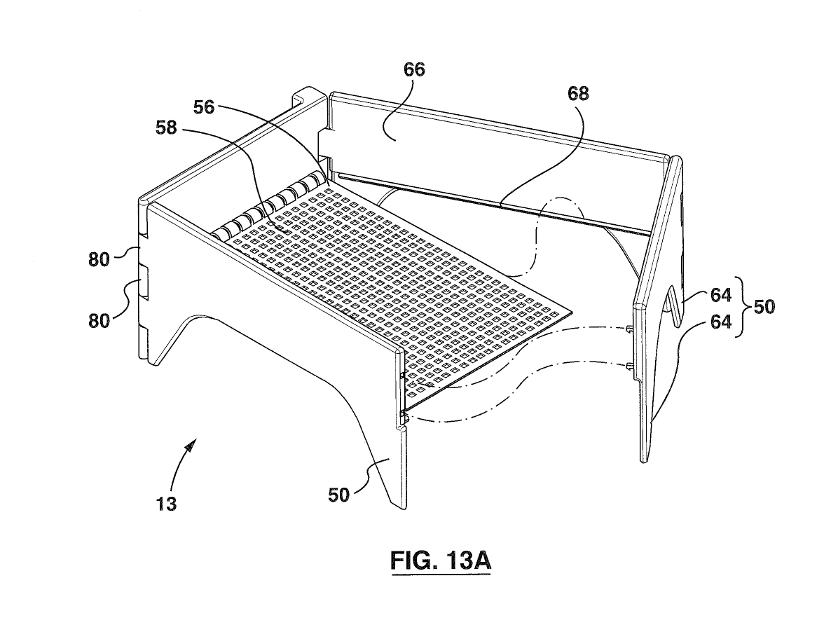

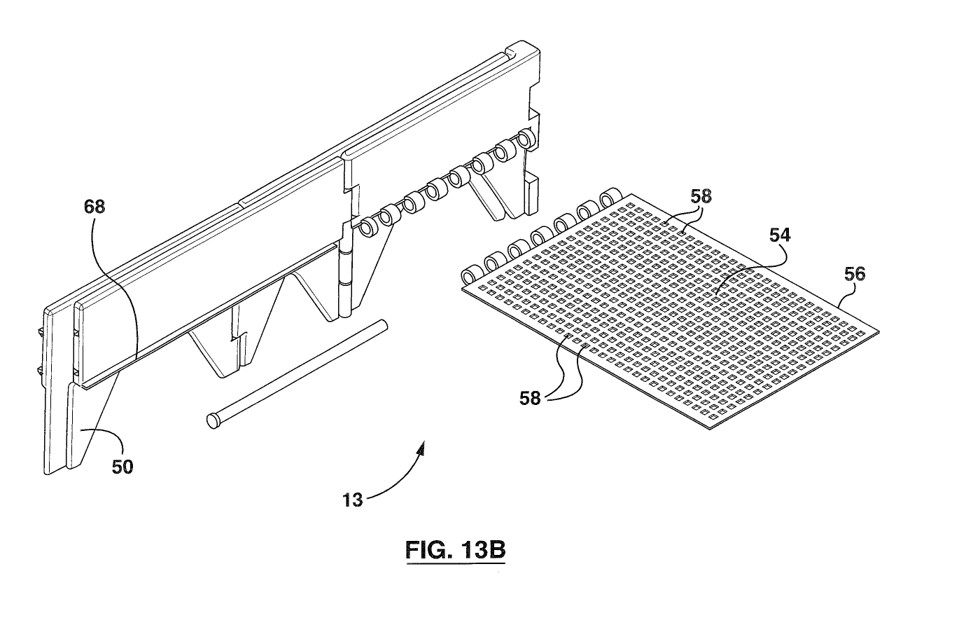

In an alternative embodiment of the present invention shown in FIGS. 13A and 13B, the frame 52 comprises a plurality of side panels 66; each side panel defining a riser 50 and a support 68 for the mesh member 56. The panels 66 each have hinging means 80 for retaining another one of said plurality of side panels 66. One of the panels and the mesh member may also be provided with means for hingedly engaging. This will allow the mesh means to be rotated out of the way and the frame to be folded for storage.

The litter sieving system according to the present invention is used to remove clumps of soiled cat litter from a granular cat litter according to the following basic method. The litter handler 12 comprising a sheet 14 having a first side 16 and a second side 18; a first end 20 and a second end 22; a first tab 24 extending from said first side 16, a second tab 26 extending from said second side 18, and a third tab 28 extending from said first end 20 is placed into a cat litter box 48 with the first tab 24, the second tab 26 and the third tab 28 extending outside the litter box 48. The user then places granular cat litter 68 inside the litter handler 12. The cat uses the litter in the ordinary manner. Eventually, it will be time to remove the soiled cat litter clumps from the litter box. After some of the cat litter 60 has been soiled causing clumps 62 of cat litter contaminated with waste material, the user brings together the first tab, the second tab and the third tab to contain the cat litter within the litter handler. The bringing together of the tabs converts the litter handler into the transport configuration. The user lifts the litter handler 12 containing the cat litter out of the litter box 48.

A second new, clean litter handler is placed into the litter box 48.

A sieve 13 comprising a riser to retain a frame at a selected distance above a litter box, said frame supporting a mesh member having a perimeter and defining a plurality of holes therethrough of sufficient size to permit granules of cat litter to pass through while retaining clumps of cat litter is placed into the litter box on top of the second new litter handler 12. The cat litter is then poured from the litter handler 12 into the sieve 13. Gently rocking the sieve from side to side will assist in bringing the granular litter into contact with the holes 58 in the mesh member, allowing them to pass through the mesh member. After all of the granular cat litter 60 has passed through the sieve 13 leaving clumps 62 of cat litter in the sieve 13, the sieve 13 is removed from the litter box and the clumps 62 of cat litter are poured back into the litter handler 12 and it is rolled up into the disposal configuration and thrown into the trash, thereby disposing of the cat litter.

Multiple litter handlers 12 may be layered inside the litter box 48 so that a supply of litter handlers is constantly available for repeated cleanings of the litter box over time.

I claim:

1. A cat litter sieving system comprising:
(a) a litter handler convertible between a flat configuration, a open container configuration, a transport configuration, and a disposal configuration; and,
(b) a sieve.

2. The cat litter sieving system of claim 1, wherein the litter handler comprises a sheet having a first side and a second side; a first tab extending from said first side, a second tab extending from said second side; a first end and a third tab extending from said first end.

3. The cat litter sieving system of claim 2, further comprising a shaping element to form the sheet into the open container configuration.

4. The cat litter sieving system of claim 2, wherein the shaping element is a curvature heat formed in the sheet to divide the sheet into a substantially planar polygonal base, and a plurality of interconnected wall panels extending upwardly from the substantially planar polygonal base to form the open container configuration.

5. The cat litter sieving system of claim 2, wherein the shaping element is a plurality of fold lines in the sheet defining substantially planar polygonal base and a plurality of interconnected wall panels; and wherein said plurality of interconnected wall panels may be folded upward from said plurality of fold lines to form an open container.

6. The cat litter sieving system of claim 5, wherein the plurality of fold lines comprise:
(a) a center fold line extending inwardly from a corner of the sheet and substantially bisecting said corner;
(b) a first lateral fold line and a second lateral fold line;
(c) said first lateral fold line and said second lateral fold line positioned one on either side of the center fold line and extending inwardly to converge with the center fold line.

7. The cat litter sieving system of claim 6, wherein the first lateral fold and the second lateral fold form a gusset corner.

8. The litter sieving system of claim 7, wherein the gusset corner is sealed.

9. The cat litter sieving system of claim 2, wherein the shaping element is a plurality of score lines in the sheet to define a substantially planar polygonal base and a plurality of interconnected wall panels; and wherein said plurality of wall panels may be folded upward from said plurality of score lines to form the open container configuration.

10. The cat litter sieving system of claim 2, wherein the sheet is constructed from a flexible sheeting material selected from the group consisting of: waterproof paper, wax paper, polyethylene terephthalate, cellulose acetate, polyvinyl chloride, polythene, nylon, acrylic, textile, and fabric.

11. The cat litter sieving system of claim 2, wherein the sheet further comprises a second side having a pair of dust retainers extending therefrom.

12. The cat litter sieving system of claim 1, wherein the sieve comprises a riser to retain a frame at a selected distance above a litter box, said frame supporting a mesh member having a perimeter and defining a plurality of holes therethrough of sufficient size to permit granules of cat litter to pass through while retaining clumps of cat litter.

13. The cat litter sieving system of claim 11, wherein the frame extends above the mesh member at all points along the perimeter thereof.

14. The cat litter sieving system of claim 11, wherein the mesh member is woven, extruded, expanded, knitted, or electroformed.

15. The cat litter sieving system of claim 11, wherein the riser, the frame and the mesh member are formed as a single body.

16. The cat litter sieving system of claim 11, wherein the riser comprises a plurality of legs removably, supportingly attached to the frame.

17. The cat litter sieving system of claim 12, wherein the frame comprises:
(a) a plurality of side panels; each side panel defining a riser and a support for the mesh member;
(b) each of said side panels having a first end having a means for retaining mating another one of said plurality of side panels; and,
(c) each of said side panels having a second end having a second means for retaining mating with another one of said plurality of side panels

18. The cat litter sieving system of claim 12, wherein:
(a) the frame comprises a plurality of side panels; each side panel defining a riser and a support for the mesh member; and having hinging means for retaining another one of said plurality of side panels; and a hinging means for engaging the mesh member; and,
(b) said mesh member comprises a means for hingedly engaging the frame.

19. A litter handler of a cat litter sieving system, said litter handler being convertible between a flat configuration, a open container configuration, a transport configuration, and a disposal configuration, for use in a cat litter sieving system, said litter handler comprising:
(a) sheet having a first side and a second side;
(b) a first tab extending from said first side,
(c) a second tab extending from said second side;
(d) a first end and a third tab extending from said first end; and
(e) a shaping element to form said sheet into the open container configuration.

20. The litter handler of claim 18, wherein the shaping element is a curvature formed in the sheet to divide the sheet into a substantially planar polygonal base, and a plurality of interconnected wall panels extending upwardly from the substantially planar polygonal base.

21. The litter handler of claim 18, wherein the shaping element is a plurality of fold lines in the sheet defining substantially planar polygonal base and a plurality of interconnected wall panels; and wherein said plurality of interconnected wall panels may be folded upward from said plurality of fold lines to form an open container.

22. The litter handler of claim 19, wherein the plurality of fold lines comprise:
(a) a center fold line extending inwardly from a corner of the sheet and substantially bisecting said corner;
(b) a first lateral fold line and a second lateral fold line;
(c) said first lateral fold line and said second lateral fold line positioned one on either side of the center fold line and extending inwardly to converge with the center fold line.

23. The litter handler of claim 22, wherein the first lateral fold and the second lateral fold form a gusset corner.

24. The litter sieving system of claim 23, wherein the gusset corner is sealed.

25. A method of removing clumps of cat litter contaminated with waste material from a granular cat litter comprising the steps of:
(a) placing a litter handler comprising a sheet having a first side and a second side; a first tab extending from said first side, a second tab extending from said second side; a first end and a third tab extending from said first end into a car litter box with the first tab, the second tab and the third tab extending outside the litter box;
(b) placing granular cat litter inside the litter handler;
(c) after some of the granular cat litter has been soiled causing clumps of cat litter contaminated with waste material, bringing the first tab into contact with the second tab forming the transport configuration containing the cat litter and cat litter clumps;
(d) lifting the litter handler out of the litter box;
(e) placing into the litter box a sieve comprising a riser to retain a frame at a selected distance above a litter box, said frame supporting a mesh member having a perimeter and defining a plurality of holes therethrough of sufficient size to permit granules of cat litter to pass through while retaining clumps of cat litter;
(f) pouring the cat litter from the litter handler into the sieve;
(g) after all of the granular cat litter has passed through the sieve leaving clumps of cat litter in the sieve, removing the sieve from the litter box and returning the clumps of cat litter into the litter handler for disposal.

26. The method of claim 25 further comprising the step of rolling litter handler around the clumps of cat litter forming the disposal configuration.
